(19) United States
(12) Patent Application Publication
(10) Pub. No.: US 2016/0245463 A1
(43) Pub. Date: Aug. 25, 2016

(54) MULTI-REFRACTION LED LAMP

(71) Applicant: STAR ELECTRICAL EQUIPMENT CO., LTD., Fujian (CN)

(72) Inventor: Guanghui Li, Xiamen (CN)

(21) Appl. No.: 15/023,669

(22) PCT Filed: Jul. 23, 2014
(86) PCT No.: PCT/CN2014/082795

§ 371 Date: Mar. 21, 2016

(51) Int. Cl. F21K 99/00; F21V 29/70; F21V 17/10; F21V 3/04

(52) U.S. Cl. CPC F21K 9/1355; F21V 3/0436; F21V 29/70; F21V 17/101; F21Y 2101/02

(57) ABSTRACT

Disclosed is a multi-refraction LED lamp composed of a lamp holder, a lamp body, a heat sink member, a circuit board, an aluminium substrate, an LED chip, a light-permeable cover and a glass shell, wherein the lamp holder is tightly fixed at a lower end of the lamp body, the heat sink member is integrally injection-moulded on an inner wall of the lamp body, the circuit board is mounted in the lamp body, the aluminium substrate is snap-fastened inside the lamp body and located above the circuit board, the LED chip is mounted on the aluminium substrate, the light-permeable cover is fixed in the lamp body and covers the aluminium substrate, the glass shell is fixed on the lamp body and covers the light-permeable cover, and the lamp holder is electrically connected to the LED chip via the circuit board.

### BACKGROUND OF THE INVENTION

1. Field of the Invention

The present invention relates to an LED lamp, and more particularly to a multi-refraction LED lamp.

2. Description of the Prior Art

A conventional LED lamp comprises a lamp holder, a lamp body, a circuit board, an aluminium substrate, an LED chip, and a glass shell. When the LED lamp works, the lamp holder is connected with a power source and supplies power to the LED chip through the circuit board, enabling the LED chip to shine. The light penetrates the glass shell to achieve illumination. However, the light irradiated from this LED lamp is not even. Accordingly, the inventor of the present invention has devoted himself based on his many years of practical experiences to solve these problems.

### SUMMARY OF THE INVENTION

The primary object of the present invention is to provide a multi-refraction LED lamp. The light radiated from the LED lamp is more even

In order to achieve the aforesaid object, the multi-refraction LED lamp of the present invention comprises a lamp holder, a lamp body, a heat sink member, a circuit board, an aluminium substrate, an LED chip, a light-permeable cover, and a glass shell. The lamp holder is tightly fixed to a lower end of the lamp body. The heat sink member is integrally formed on an inner wall of the lamp body by injection-molding. The circuit board is mounted in the lamp body. The aluminium substrate is snap-fastened inside the lamp body and located above the circuit board. The LED chip is mounted on the aluminium substrate. The light-permeable cover is fixed in the lamp body and covers the aluminium substrate. The glass shell is fixed on the lamp body and covers the light-permeable cover. The lamp holder is electrically connected with the LED chip via the circuit board.

Preferably, the glass shell, the light-permeable cover, and the lamp body are made of a PC (Poly Carbonate) material.

When the present invention works, the lamp holder is connected with a power source and supplies power to the LED chip through the circuit board, enabling the LED chip to shine. The light is refracted by the light-permeable cover and then refracted by the glass shell to diffuse the light for illumination. The light radiated from the LED lamp is more even because it refracted many times via air-the light-permeable cover; the light-permeable cover-air; air-the glass shell; the glass shell-air.

Embodiments of the present invention will now be described, by way of example only, with reference to the accompanying drawings.

### BRIEF DESCRIPTION OF THE DRAWINGS

FIG. 1 is an exploded view of the present invention;

FIG. 2 is a sectional view of the present invention; and

FIG. 3 is a perspective view of the present invention.

### DETAILED DESCRIPTION OF THE PREFERRED EMBODIMENTS

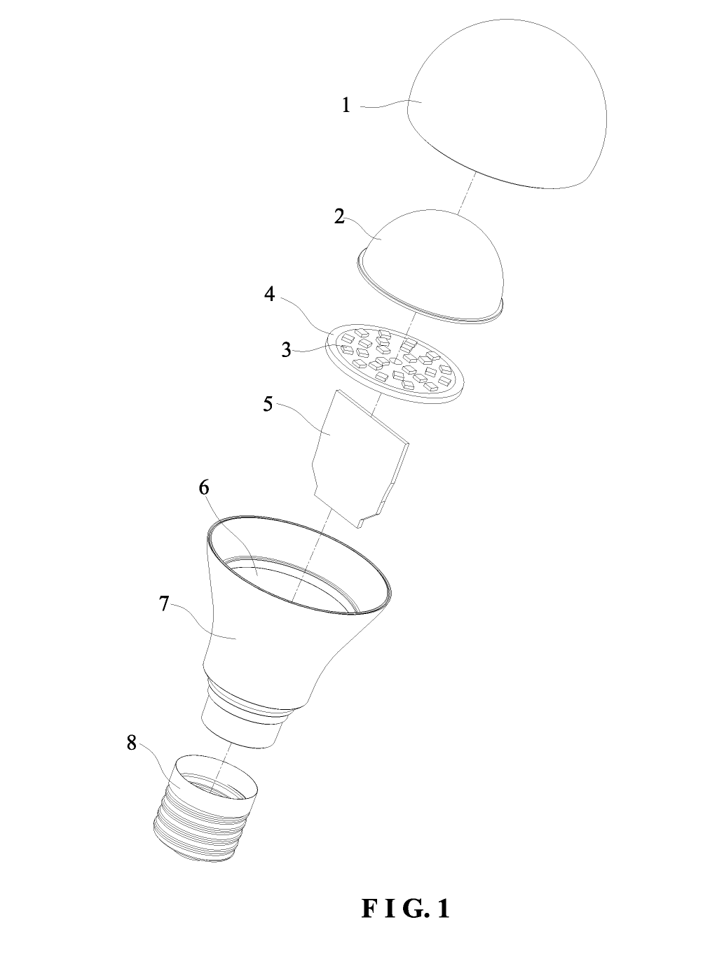

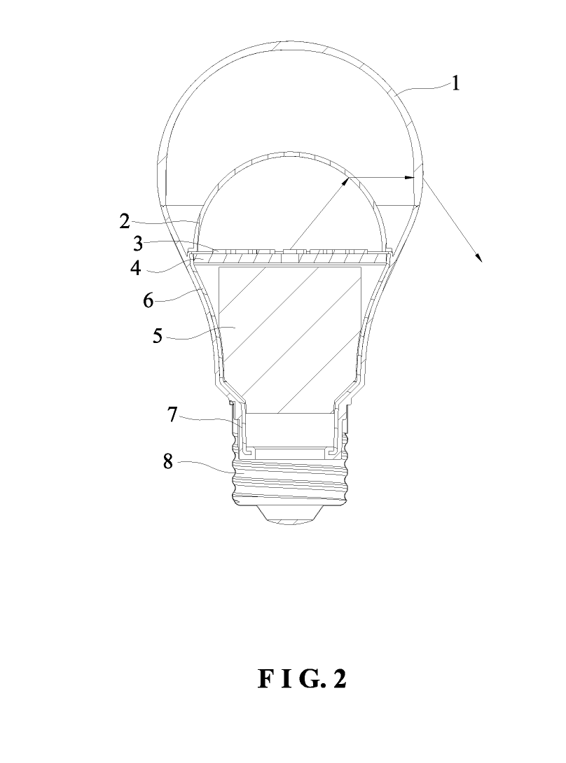

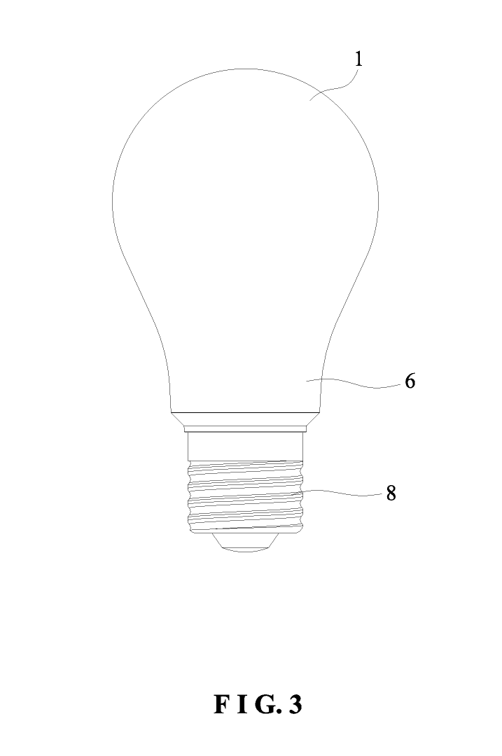

As shown in FIG. 1 through FIG. 3, the present invention discloses a multi-refraction LED lamp. The multi-refraction LED lamp comprises a lamp holder 8, a lamp body 7, a heat sink member 6, a circuit board 5, an aluminium substrate 4, an LED chip 3, a light-permeable cover 2, and a glass shell 1.

The lamp holder 8 is tightly fixed to a lower end of the lamp body 7.

The heat sink member 6 is integrally formed on an inner wall of the lamp body 7 by injection-molding.

The circuit board 5 is mounted in the lamp body 7.

The aluminium substrate 4 is snap-fastened inside the lamp body 7 and located above the circuit board 5.

The LED chip 3 is mounted on the aluminium substrate 4. When in use, the heat generated by the LED chip 3 is radiated through the aluminium substrate 4 and the heat sink member 6.

The light-permeable cover 2 is fixed in the lamp body 7 by ultrasonic welding. The light-permeable cover covers the aluminium substrate 4. The light-permeable cover 2 can be fixed in the lamp body 7 by snap joints, screw joints or bond.

The glass shell 1 is fixed on the lamp body 7 by ultrasonic welding. The glass shell 1 covers the light-permeable cover 2. The glass shell 1 can be fixed on the lamp body 7 by snap joints, screw joints or bond.

The lamp holder 8 is electrically connected with the LED chip 3 via the circuit board 5.

Preferably, the glass shell 1, the light-permeable cover 2, and the lamp body 7 are made of a PC (Poly Carbonate) material.

When the present invention works, the lamp holder 8 is connected with a power source and supplies power to the LED chip 3 through the circuit board 5, enabling the LED chip 3 to shine. The light is refracted by the light-permeable cover and then refracted by the glass shell to diffuse the light for illumination. The light radiated from the LED lamp is more even because it refracted many times via air-the light-permeable cover; the light-permeable cover-air; air-the glass shell; the glass shell-air.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A multi-refraction LED lamp, comprising a lamp holder, a lamp body, a heat sink member, a circuit board, an aluminium substrate, an LED chip, a light-permeable cover, and a glass shell; the lamp holder being tightly fixed to a lower end of the lamp body, the heat sink member being integrally formed on an inner wall of the lamp body by injection-molding, the circuit board being mounted in the lamp body, the aluminium substrate being snap-fastened inside the lamp body and located above the circuit board, the LED chip being mounted on the aluminium substrate, the light-permeable cover being fixed in the lamp body and covering the aluminium substrate, the glass shell being fixed on the lamp body and covering the light-permeable cover, the lamp holder being electrically connected with the LED chip via the circuit board.

2. The multi-refraction LED lamp as claimed in claim 1, wherein the glass shell, the light-permeable cover, and the lamp body are made of a PC (Poly Carbonate) material.
